(19) United States
(12) Patent Application Publication
(10) Pub. No.: US 2008/0276472 A1
(43) Pub. Date: Nov. 13, 2008

(54) Apparatus for measuring angle in relation to a remote surface

(76) Inventor: Michael Riskus, Boynton Beach, FL (US)

Correspondence Address: RICHARD S. ROSS, ESQ., 4801 S. UNIVERSITY DR., # 237, FT. LAUDERDALE, FL, 33328, US

(21) Appl. No.: 11/800,508

(22) Filed: May 7, 2007

(51) Int. Cl. G01C 1/00

(52) U.S. Cl. 33/284

(57) ABSTRACT

An apparatus for making measurements is disclosed. The apparatus includes a straight elongated element and a first laser distance meter rotatably coupled to a first end of the straight element. The apparatus further includes a second laser distance meter rotatably coupled to a second end of the straight element. The apparatus further includes a processor for determining a current angle of the straight element in relation to a remote straight surface based on distance readings from the first and the second laser distance meters. The apparatus further includes a display located on the straight element for displaying the current angle of the straight element as determined by the processor.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of construction and home improvement, and more particularly relates to the field of handheld tools for measuring distances and angles.

### BACKGROUND OF THE INVENTION

The construction of homes and buildings, as well as home improvement performed on residences, often requires builders to establish parallels, right angles or varied angles to other objects. For example, during the construction or improvement of a home, it is often necessary to establish that one wall is parallel or perpendicular to another. Further, some home designs require that one wall or object is at a less common angle, such as 45 degrees, to a nearby wall. Additionally, sometimes roofs and ceilings are required to be built at a particular slope. At times, a center or mid-point must be found between two objects, such as two opposing walls. These needs have spawned a series of tools and approaches to make the above measurements.

One popular approach to the problems above is to take two distance measurements at various locations and using these distance measurements to calculate a parallel line, a perpendicular line or an angled line to the remote object. This approach can also be used to determine a mid-point between two objects. This approach, however, can be flawed if the distance measurements are not taken with enough accuracy. Further, this approach may require some calculations to be made by the user, which may be subject to some error. These drawbacks may not be acceptable in light of time and/or accuracy constraints on the building or home improvement process.

Therefore, a need exists to overcome the problems with the prior art as discussed above, and particularly for a more efficient way to measure distances and angles in relation to another surface.

### SUMMARY OF THE INVENTION

Briefly, according to an embodiment of the present invention, an apparatus for making measurements is disclosed. The apparatus includes a straight elongated element and a first laser distance meter rotatably coupled to a first end of the straight element. The apparatus further includes a second laser distance meter rotatably coupled to a second end of the straight element. The apparatus further includes a processor for determining a current angle of the straight element in relation to a remote straight surface based on distance readings from the first and the second laser distance meters. The apparatus further includes a display located on the straight element for displaying the current angle of the straight element as determined by the processor.

In another embodiment of the present invention, an apparatus for making measurements is disclosed. The apparatus includes a straight elongated element including at least one level embedded in the straight element for leveling the straight element. The apparatus further includes a first and second laser distance meter, each laser distance meter rotatably coupled to opposing ends of the straight element. The apparatus further includes a processor for determining a current angle of the straight element in relation to a remote straight surface based on distance readings from the first and the second laser distance meters. The apparatus further includes at least one display located on the straight element for displaying the distance readings from the first and the second laser distance meters and the current angle of the straight element as determined by the processor.

In another embodiment of the present invention, an apparatus for making measurements is disclosed. The apparatus includes a straight elongated element and two levels perpendicular to each other, each level embedded in the straight element for leveling the straight element. The apparatus further includes a first laser distance meter rotatably coupled to a first end of the straight element and a second laser distance meter rotatably coupled to a second end of the straight element. The apparatus further includes a processor for determining a current angle of the straight element in relation to a remote straight surface based on distance readings from the first and the second laser distance meters. The apparatus further includes a first display located on the straight element for displaying the current angle of the straight element as determined by the processor, a second display located on the straight element for displaying the distance reading from the first laser distance meter, and a third display located on the straight element for displaying the distance reading from the second laser distance meter.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a frontal view of the measuring apparatus for measuring angles and distances, in accordance with one embodiment of the present invention.

FIG. 2 is an illustration of a frontal view of the measuring apparatus during use, in accordance with one embodiment of the present invention.

FIG. 3 is an illustration of a block diagram showing the inner components of the measuring apparatus, in accordance with one embodiment of the present invention.

FIG. 4 is an illustration of a frontal view of the measuring apparatus during use, in accordance with one embodiment of the present invention.

FIG. 5 is an illustration of a side view of the measuring apparatus, in accordance with one embodiment of the present invention.

### DETAILED DESCRIPTION

The present invention solves problems with the prior art by providing a simplified apparatus for measuring the angle of the apparatus in relation to a remote surface. The apparatus of the present invention utilizes readings from a pair of laser distance meters, wherein the meters are coupled to opposite ends of a straightedge, in order to determine the angle of the straightedge in relation to a remote surface, such as a wall, a ceiling, a roof or a floor. For example, the apparatus may be used to find the angle at which the straightedge is positioned in relation to a wall. A processor embedded in the straightedge executes the process of determining the angle of the straightedge and may display this information in one or more displays located on the straightedge. The apparatus of the present invention may also include at least one level for leveling the straightedge when determining the angle of the straightedge. The apparatus may also include at least one display for displaying distance readings taken from each of the pair of laser distance readings.

In addition to determining the angle of the straightedge in relation to a remote surface, the apparatus of the present invention may further be used to find an angle or slope of a surface, such as a wall, a floor, a ceiling or a roof. For example, the apparatus may be used to find a 45 degree angle, a 90 degree angle or a parallel line to a straight wall. The apparatus of the present invention may further be used to find the center-point between two opposing surfaces, such as walls.

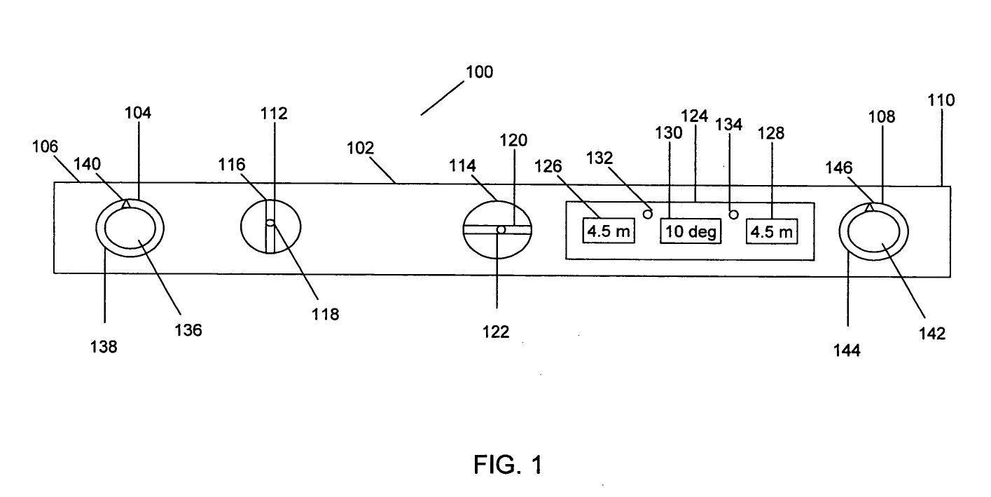

FIG. 1 is an illustration of a frontal view of the measuring apparatus 100 for measuring angles and distances, in accordance with one embodiment of the present invention. Measuring apparatus 100 includes a straight elongated element 102, which may comprise a metallic rectangular element resembling a ruler or a large measuring stick. Measuring apparatus 100 further includes a first laser distance meter 104 rotatably coupled to a first end 106 of the straight element 102. Measuring apparatus 100 further includes a second laser distance meter 108 rotatably coupled to a second end 110 of the straight element 102.

Also included in the measuring apparatus 100 is a first level 112 and a second level 114, for leveling the straight element 102 before the apparatus 100 determines the current angle of the straight element 102 in relation to a remote straight surface. The first level 112 comprises a straight, hollow elongated tube 116 within which a bubble 118 is suspended in a liquid and the second level 114 comprises a straight, hollow elongated tube 120 within which a bubble 122 is suspended in a liquid. Note that the first level 112 and the second level 114 are perpendicular to each other. This allows for the measuring of the true horizontal when the straight element 102 is positioned either horizontally or vertically.

Also included in the measuring apparatus 100 is a display panel 124 located on the straight element 102 for displaying various data. For example, display 126 in display panel 124 may display the distance reading from laser distance meter 104 and display 128 may display the distance reading from laser distance meter 108. Further, display 130 may display the current angle of the straight element 102 in relation to a remote straight surface (based on distance readings from the first and the second laser distance meters 104, 108) as determined by a processor located within straight element 102. Each display 126, 128 and 130 within display set 124 may include a digital display, an LCD display or a mechanical display.

Also included in the display panel 124 of the measuring apparatus 100 is a first button 132 and a second button 134. One of the many functions that may be performed by one or both buttons 132, 134 includes holding or freezing the information displayed in displays 126, 128 and 130 so as to allow a user to write or read the information in the displays. Another one of the many functions that may be performed by one or both buttons 132, 134 includes switching the mode of the displays 126 and 128 between a normal distance display mode and a plus/minus distance display mode. The different modes of the displays 126, 128 are described in greater detail below.

Each of the first and second laser distance meters 104, 108 includes a laser emitter, a sensor for receiving an incoming laser signal and a processor for analyzing an incoming laser signal and determining a distance between the laser distance meter and a remote object from which the incoming laser was reflected. The first laser distance meter 104 is rotatably embedded within the first end 106 of the straight element 102. Specifically, the first laser distance meter 104 comprises a circular element 136 that may rotate within a circular socket 138. The direction indicator 140 of the first laser distance meter 104 indicates the direction in which the laser emitter of the first laser distance meter 104 is pointing. Also, the second laser distance meter 108 comprises a circular element 142 that may rotate within a circular socket 144. The direction indicator 146 of the second laser distance meter 108 indicates the direction in which the laser emitter of the second laser distance meter 108 is pointing. Each laser distance meter 104, 108 may include a stationary circular ring surrounding each circular element 136, 142, wherein the stationary circular ring includes angle (i.e., degree or grad) markings.

Also included in the measuring apparatus 100, but not shown in FIG. 1, is a first processor for determining the current angle of the straight element 102 in relation to a remote straight surface based on a first distance reading “a” from the first laser distance meter 104 and a second distance reading “b” from the second laser distance meter 106, wherein the current angle of the straight element 102 in relation to the remote straight surface is calculated as:

sin⁻¹ (|a−b|/x)

wherein x is the distance between the first and second laser distance meters 104, 106. Further, included in the measuring apparatus 100, but not shown in FIG. 1, is a conductor for communicably coupling the first laser distance meter 104 with the first processor and a conductor for communicably coupling the second laser distance meter 108 with the first processor.

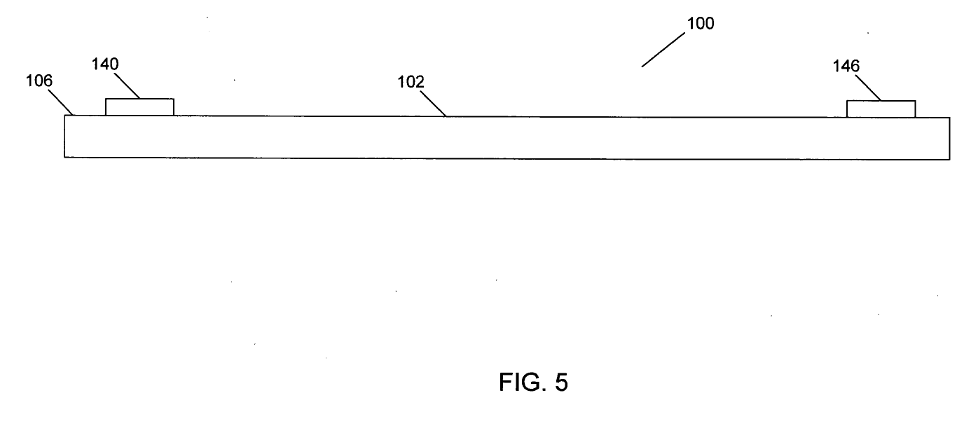

FIG. 5 is an illustration of a side view of the measuring apparatus 100, in accordance with one embodiment of the present invention. FIG. 5 shows the first laser distance meter 104 is coupled to a top surface of the straight element 102. As explained above, the first laser distance meter 104 rotates within a circular socket. FIG. 5 further shows the second laser distance meter 108 is coupled to a top surface of the straight element 102.

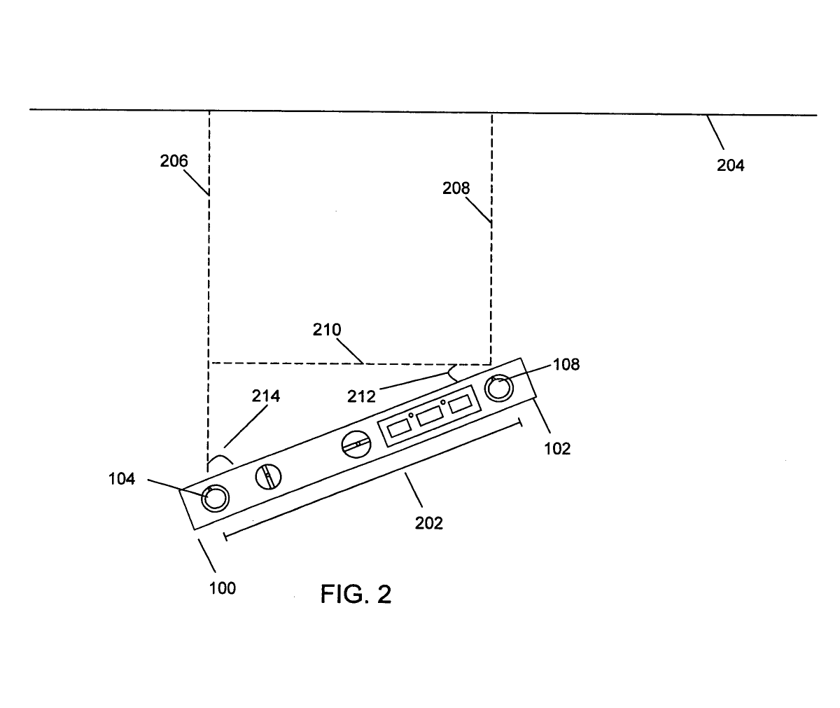

FIG. 2 is an illustration of a frontal view of the measuring apparatus 100 during use, in accordance with one embodiment of the present invention. FIG. 2 shows the measuring apparatus 100 being used to measure the current angle 212 of the straight element 102 in relation to a remote straight surface 204, which may be a wall, a ceiling, a roof, or a floor. Note that the process of determining the current angle 212 is executed by a first processor capable of performing the mathematical processes described below.

The process of determining the current angle 212 of the straight element 102 in relation to a remote straight surface 204 comprises taking a first distance reading “a” 206 from the first laser distance meter 104 and a second distance reading “b” 208 from the second laser distance meter 106. Line 210 shows a straight line parallel to the remote straight element 204. The distance 202 between the first and second laser distance meters 104, 106 is represented as “x.” The current angle 212 of the straight element 102 in relation to the remote straight surface 204 is calculated as:

sin⁻¹ (|a−b|/x)

Alternatively, the angle 212 may be calculated as:

sin⁻¹ ((a−b)/x), wherein a>b.

The apparatus 100 of the present invention may also measure angle 214 by taking a first distance reading “a” 206 from the first laser distance meter 104 and a second distance reading “b” 208 from the second laser distance meter 106. The distance 202 between the first and second laser distance meters 104, 106 is represented as “x.” The angle 214 is calculated as:

90 degrees−sin⁻¹ (|a−b|/x)

Alternatively, the angle 214 may be calculated as:

90 degrees−sin⁻¹ (|a−b|/x), wherein a>b.

The positioning of the apparatus 100 as shown in FIG. 2 would produce data being displayed in displays 126, 128 and 130. Specifically, when in normal distance display mode, the display 126 would display value “a” 206, the display 128 would display value “b” 208 and display 130 would display the current angle 212 (or angle 214). Displays 126, 128 may display distance values in any proper units of measuring distance, such as inches, feet, centimeters or meters, and display 130 may display angle values in any proper units for measuring angles, such as degrees or grads.

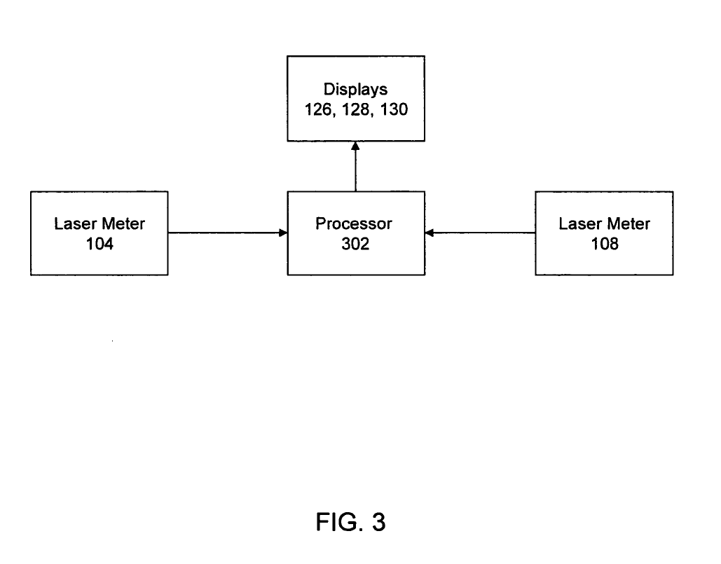

FIG. 3 is an illustration of a block diagram showing the inner components of the measuring apparatus 100, in accordance with one embodiment of the present invention. FIG. 3 shows that first laser distance meter 104 is conductively coupled to the processor 302, which measures the current angle 212 of the straight element 102 in relation to a remote straight surface 204. The processor 302 may be any commercially available microprocessor or application specific integrated circuit programmed for performing the processes described herein. The processor 302 reads a first distance reading “a” 206 from the first laser distance meter 104 via the conductive connection to first laser distance meter 104. FIG. 3 further shows that second laser distance meter 108 is conductively coupled to the processor 302. The processor 302 reads a second distance reading “b” 208 from the second laser distance meter 108 via the conductive connection to second laser distance meter 108.

FIG. 3 shows that displays 126, 128 and 130 are also conductively coupled to processor 302. The processor 302 produces the data being displayed in displays 126, 128 and 130. Specifically, when in normal distance display mode, the processor 302 controls display 126 to display value “a” 206, the display 128 to display value “b” 208 and display 130 to display the current angle 212.

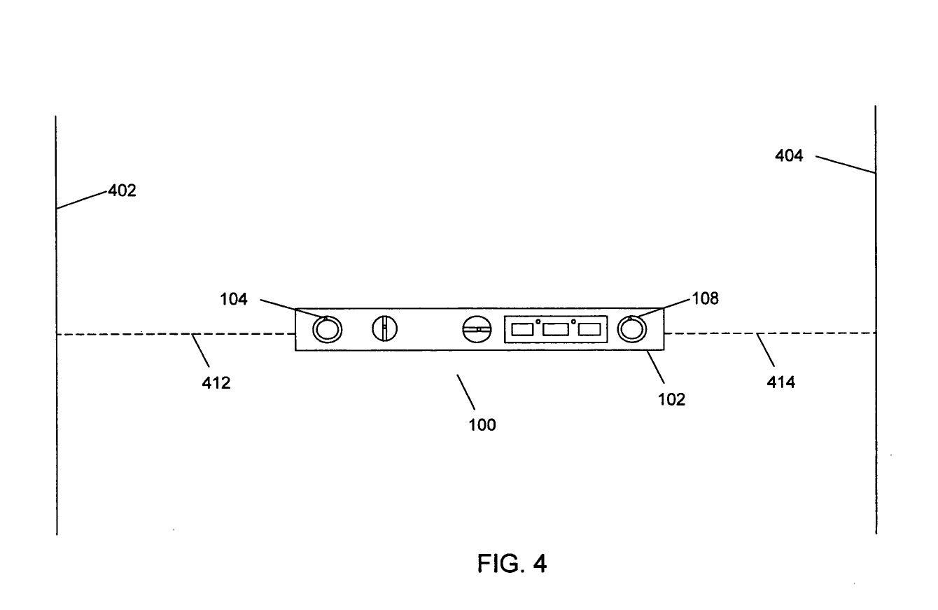

FIG. 4 is an illustration of a frontal view of the measuring apparatus 100 during use, in accordance with one embodiment of the present invention. FIG. 4 shows the measuring apparatus 100 being used to measure the midway point between two remote surfaces (i.e., walls) 402 and 404. The first laser distance meter 104 measures distance 412 while second laser distance meter 108 measures distance 414.

The positioning of the apparatus 100 as shown in FIG. 4 would produce data being displayed in displays 126, 128. Specifically, when in plus/minus distance display mode, the display 126 would display a distance value 412 and the display 128 would display a distance value 414. The midway point between walls 402, 404 is reached by the apparatus 100 when values 412, 414 are equal. Alternatively, the display 126 may display a plus/minus distance value 412 and the display 128 may display a plus/minus distance value 414, wherein a plus value indicates the distance toward the corresponding wall towards which the apparatus 100 should be moved and wherein a minus value indicates the distance away from the corresponding wall from which the apparatus 100 should be moved, so as to reach the midway point between walls 402, 404 with the apparatus 100. In this alternative, the midway point between walls 402, 404 is reached by the apparatus 100 when values 412, 414 reach zero.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

I claim:

1. An apparatus for making measurements, comprising:
a straight elongated element;
a first laser distance meter rotatably coupled to a first end of the straight element;
a second laser distance meter rotatably coupled to a second end of the straight element;
a processor for determining a current angle of the straight element in relation to a remote straight surface based on distance readings from the first and the second laser distance meters; and
a display located on the straight element for displaying the current angle of the straight element as determined by the processor.

2. The apparatus of claim 1, further comprising;
a conductor for communicably coupling the first laser distance meter with the processor; and
a conductor for communicably coupling the second laser distance meter with the processor.

3. The apparatus of claim 2, wherein the straight elongated element comprises an elongated, metallic rectangular element.

4. The apparatus of claim 3, wherein the first and second laser distance meter comprises:
a laser emitter;
a sensor for receiving an incoming laser signal;
a processor for analyzing an incoming laser signal and determining a distance between the laser distance meter and a remote object from which the incoming laser was reflected.

5. The apparatus of claim 4, wherein the first laser distance meter is rotatably embedded within the first end of the straight element.

6. The apparatus of claim 5, wherein the second laser distance meter is rotatably embedded within the second end of the straight element.

7. The apparatus of claim 6, wherein the at least one level comprises at least one straight elongated tube within which a bubble is suspended in a liquid.

8. The apparatus of claim 6, wherein the processor further comprises:
a processor for determining the current angle of the straight element in relation to a remote straight surface based on a first distance reading “a” from the first laser distance meter and a second distance reading “b” from the second laser distance meter, wherein the current angle of the straight element in relation to the remote straight surface is calculated as:
sin⁻¹ (|a−b|/x)
wherein x is the distance between the first and second laser distance meters.

9. The apparatus of claim 2, further comprising:
at least one level embedded in the straight element for leveling the straight element before the processor determines the current angle of the straight element in relation to a remote straight surface.

10. The apparatus of claim 9, further comprising:
at least one display for displaying the distance readings from the first and the second laser distance meters.

11. An apparatus for making measurements, comprising:
a straight elongated element including at least one level embedded in the straight element for leveling the straight element;
a first and second laser distance meter, each laser distance meter rotatably coupled to opposing ends of the straight element;
a processor for determining a current angle of the straight element in relation to a remote straight surface based on distance readings from the first and the second laser distance meters; and
at least one display located on the straight element for displaying the distance readings from the first and the second laser distance meters and the current angle of the straight element as determined by the processor.

12. The apparatus of claim 11, further comprising;
a conductor for communicably coupling the first laser distance meter with the processor; and
a conductor for communicably coupling the second laser distance meter with the processor.

13. The apparatus of claim 12, wherein the straight elongated element comprises an elongated, metallic rectangular element.

14. The apparatus of claim 13, wherein the first and second laser distance meter comprises:
a laser emitter;
a sensor for receiving an incoming laser signal;
a processor for analyzing an incoming laser signal and determining a distance between the laser distance meter and a remote object from which the incoming laser was reflected.

15. The apparatus of claim 14, wherein the first and second laser distance meters are rotatably embedded within the straight element.

16. The apparatus of claim 15, wherein the processor further comprises:
a processor for determining the current angle of the straight element in relation to a remote straight surface based on a first distance reading “a” from the first laser distance meter and a second distance reading “b” from the second laser distance meter, wherein the current angle of the straight element in relation to the remote straight surface is calculated as:
sin⁻¹ (|a−b|/x)
wherein x is the distance between the first and second laser distance meters.

17. An apparatus for making measurements, comprising:
a straight elongated element;
two levels perpendicular to each other, each level embedded in the straight element for leveling the straight element;
a first laser distance meter rotatably coupled to a first end of the straight element;
a second laser distance meter rotatably coupled to a second end of the straight element;
a processor for determining a current angle of the straight element in relation to a remote straight surface based on distance readings from the first and the second laser distance meters; and
a first display located on the straight element for displaying the current angle of the straight element as determined by the processor;
a second display located on the straight element for displaying the distance reading from the first laser distance meter; and
a third display located on the straight element for displaying the distance reading from the second laser distance meter.

18. The apparatus of claim 17, further comprising;
a conductor for communicably coupling the first laser distance meter with the processor; and
a conductor for communicably coupling the second laser distance meter with the processor.

19. The apparatus of claim 18, wherein the first and second laser distance meter comprises:
a laser emitter;
a sensor for receiving an incoming laser signal;
a processor for analyzing an incoming laser signal and determining a distance between the laser distance meter and a remote object from which the incoming laser was reflected.

20. The apparatus of claim 19, wherein the processor further comprises:
a processor for determining the current angle of the straight element in relation to a remote straight surface based on a first distance reading “a” from the first laser distance meter and a second distance reading “b” from the second laser distance meter, wherein the current angle of the straight element in relation to the remote straight surface is calculated as:
sin⁻¹ (|a−b|/x)
wherein x is the distance between the first and second laser distance meters.
